(19) United States
(12) Patent Application Publication
(10) Pub. No.: US 2004/0101387 A1
(43) Pub. Date: May 27, 2004

(54) Exchange method and mechanism for a component of the magnetic head and the suspension or the head gimbal assembly of the hard disk driver during manufacture

(76) Inventors: Ming Gao Yao, Dongguan City (CN); Masashi Shiraishi, Hung Hom (HK); Yi Ru Xie, Dongguan City (CN)

Correspondence Address: KENYON & KENYON, Suite 600, 333 W. San Carlos, Street, San Jose, CA, 95110-2711, US

(21) Appl. No.: 10/644,947

(22) Filed: Aug. 19, 2003

(30) Foreign Application Priority Data
Nov. 25, 2002 (WO) PCT/CN02/00843

(51) Int. Cl. B65F 3/02

(52) U.S. Cl. 414/405

(57) ABSTRACT

A method and mechanism for visually inspecting both sides of components for a hard disk drive are disclosed. The components are stored in the containment units of a packing tray, with an exchange tray with matching containment units placed above and in contact with the packing tray. The components could be magnetic read/write heads, head gimbal assemblies, or other parts of hard disk drive. The two trays are rotated, using gravity to cause the components to move from the packing containment unit to the exchange containment unit.

### BACKGROUND INFORMATION

The present invention relates to magnetic hard disk drives. More specifically, the present invention relates to a method of inspecting magnetic read/write heads and micro-actuators during the manufacturing process.

In the art today, different methods are utilized to improve recording density of hard disk drives. FIG. 1 provides an illustration of a typical disk drive with a typical drive arm 102 configured to read from and write to a magnetic hard disk 104. Typically, voice-coil motors (VCM) 106 are used for controlling a hard drive's arm 102 motion across a magnetic hard disk 106. Because of the inherent tolerance (dynamic play) that exists in the placement of a recording head 108 by a VCM 106 alone, micro-actuators 110 are now being utilized to ‘fine-tune’ head 108 placement. A VCM 106 is utilized for course adjustment and the micro-actuator 110 then corrects the placement on a much smaller scale to compensate for the VCM's 106 (with the arm 102) tolerance. This enables a smaller recordable track width, increasing the ‘tracks per inch’ (TPI) value of the hard drive (increased drive density).

FIG. 2 provides an illustration of a micro-actuator as used in the art. Typically, a slider 202 (containing a read/write magnetic head; not shown) is utilized for maintaining a prescribed flying height above the disk surface 104 (See FIG. 1). Micro-actuators may have flexible beams 204 connecting a support device 206 to a slider containment unit 208 enabling slider 202 motion independent of the drive arm 102 (See FIG. 1). An electromagnetic assembly or an electromagnetic/ferromagnetic assembly (not shown) may be utilized to provide minute adjustments in orientation/location of the slider/head 202 with respect to the arm 102 (See FIG. 1).

The component parts of the hard disk drive usually need to be inspected on each side during the manufacture. Normally, this involves removing the parts from their packing trays one by one with a pair of tweezers or air tweezers. This handling often leads to damage to the component, as well as taking a great deal of time, which increase the unit cost of the component of the hard disk drive.

### BRIEF DESCRIPTION OF THE DRAWINGS

FIG. 1 provides an illustration of an internal view of a hard disk drive including a drive arm configured to read from and write to a magnetic hard disk as used in the art.

FIG. 2 provides an illustration of a micro-actuator as used in the art.

FIG. 3 describes a hard disk drive head gimbal assembly (HGA) with a ‘U’ shaped micro-actuator.

FIGS. 4a-b provide an illustration of one embodiment of a micro-actuator and magnetic read/write head.

FIGS. 5a-d provide an illustration of one embodiment of a packing tray and an exchange tray for a micro-actuator or a magnetic read/write head.

FIGS. 6a-g provide an illustration of a method for using the packing tray and the exchange tray to inspect both sides of a micro-actuator or a magnetic read/write head.

FIG. 7 provides an illustration of one embodiment of a head gimbal assembly packing tray.

FIGS. 8a-d provide an illustration of a first method for using the head gimbal assembly packing tray.

FIGS. 9a-b provide an illustration of one embodiment of a head gimbal assembly exchange tray.

FIGS. 10a-f provides an illustration of a first method for using the head gimbal assembly packing tray and the head gimbal assembly exchange tray.

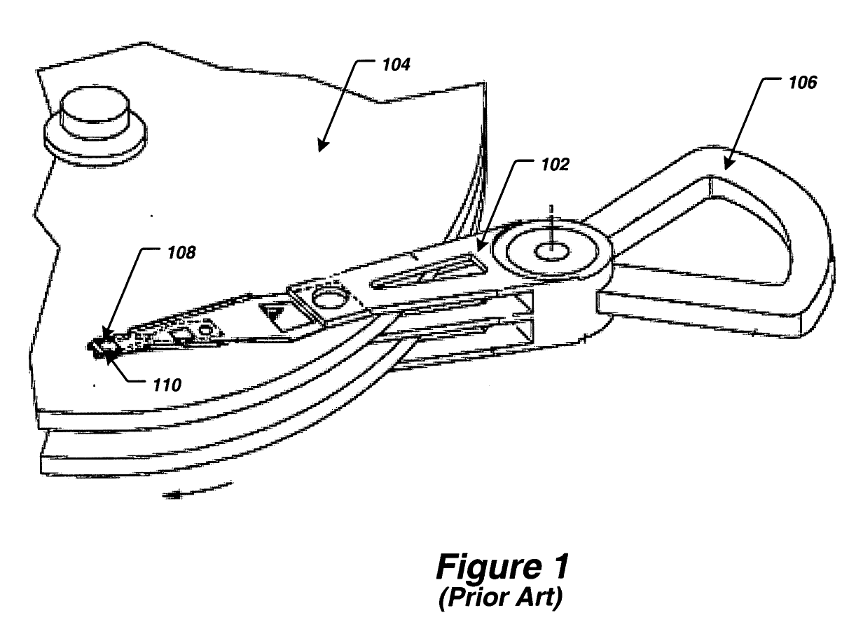

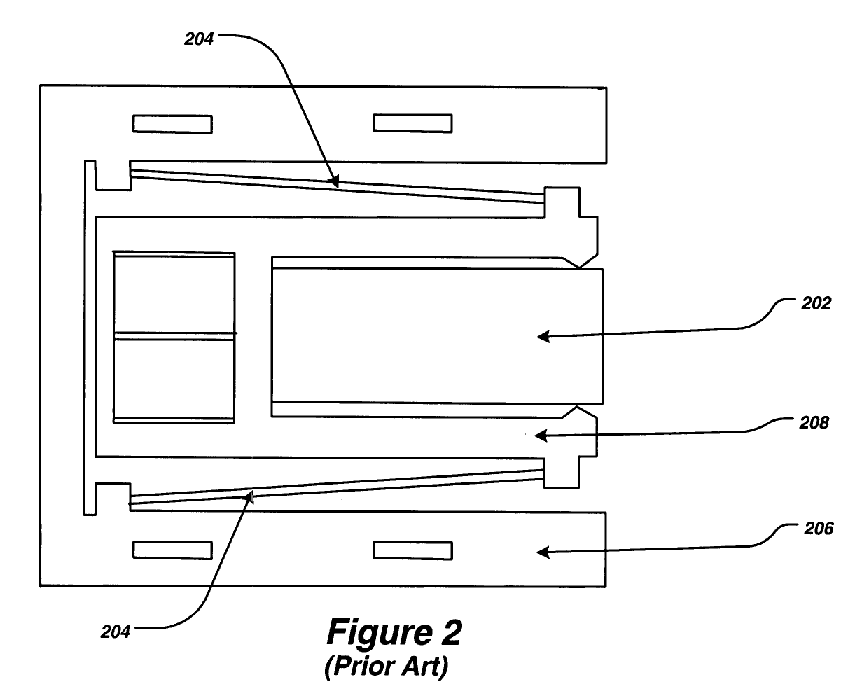

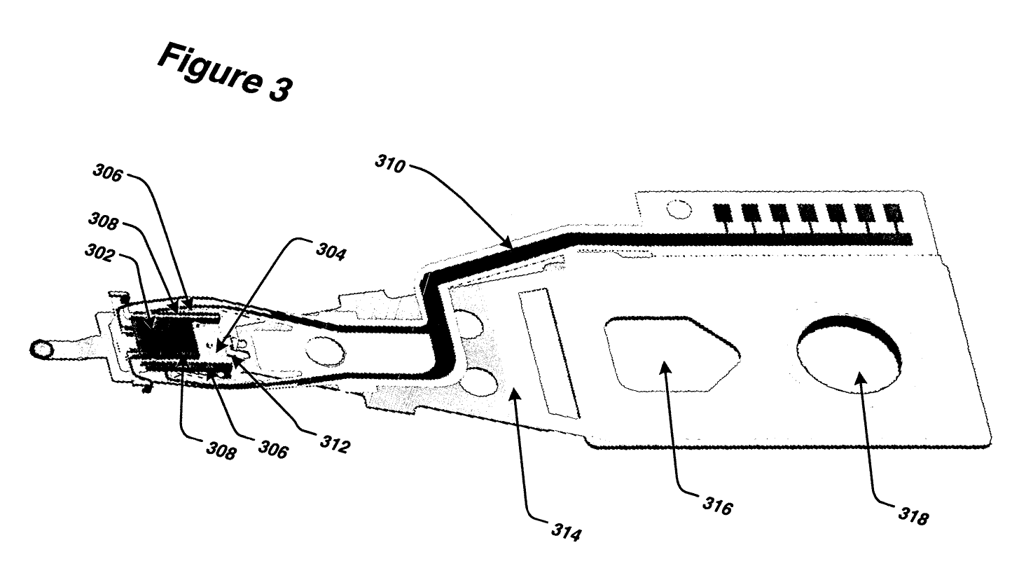

### DETAILED DESCRIPTION

A method and mechanism for visually inspecting both sides of components for a hard disk drive are disclosed. In one embodiment, the components are stored in the containment units of a packing tray, with an exchange tray with matching containment units placed above and in contact with the packing tray. In a further embodiment, the components could be micro-actuators, magnetic read/write heads, head suspensions, head gimbal assemblies, or other parts of a hard disk drive. In one embodiment, the two trays are rotated, using gravity to cause the components to move from the packing containment unit to the exchange containment unit.

Illustrated in an upside-down orientation, FIG. 3 describes one embodiment of a hard disk drive head gimbal assembly (HGA) with a ‘U’-shaped micro-actuator. In one embodiment, a slider 302 is coupled to a ‘U’-shaped micro-actuator. In a further embodiment, the base 304 of the ‘U’-shaped micro-actuator has an arm 306 on each side, with a piezoelectric Lead Zirconate Titanate (PZT) beam (arm) 308 attached to each arm 306. In one embodiment, a printed circuit assembly 310 is electrically coupled to the slider 302 to control reading and writing functions. The micro-actuator is coupled to a suspension assembly 312, the suspension assembly being part of the head gimbal assembly (HGA) 314. A first hole 316 is cut into the HGA 314 to reduce weight. A second hole 318 allows the HGA 314 to be mounted on a pivot.

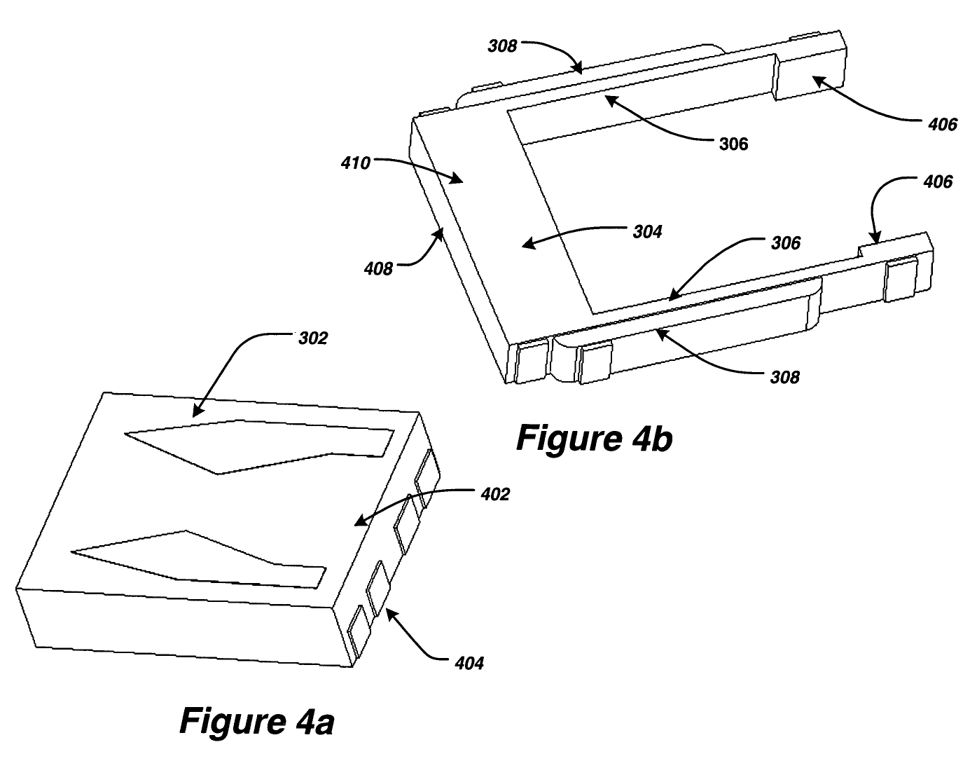

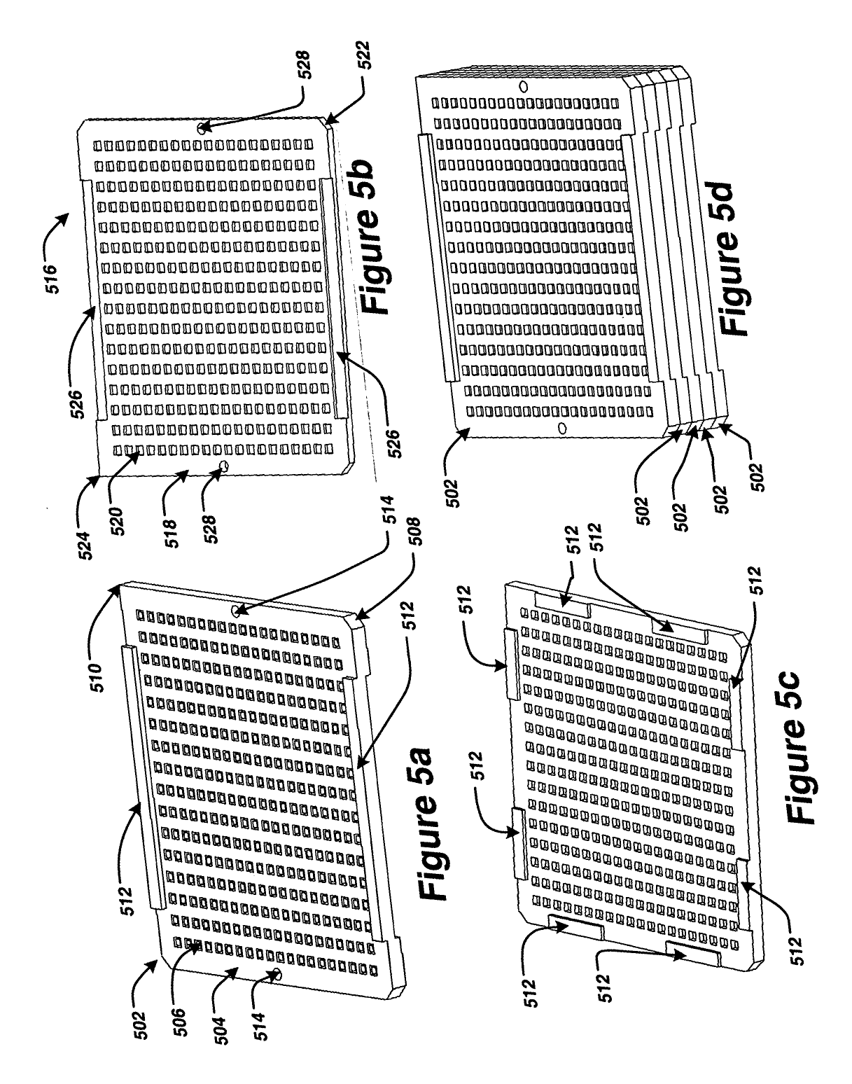

FIGS. 4a-b illustrate one embodiment of a micro-actuator and slider 302. FIG. 4a illustrates one embodiment of the slider. In one embodiment, the slider has a top view 402 and a bottom view 404, each of which must be visually examined during manufacture. FIG. 4b illustrates one embodiment of the micro-actuator. In one embodiment, the micro-actuator has a base piece 304 with two arms 306 extending from the base piece 304. In a further embodiment, each arm 306 has a piezoelectric beam 308 coupled to each arm 306. In one embodiment, the slider 302 is coupled to the micro-actuator at a point 406 on each arm 306. The micro-actuator has a top side 408 and a bottom side 410, each of which must be visually examined during manufacture.

FIGS. 5a-d illustrate one embodiment of the exchange tray and packing trays. FIG. 5a shows one embodiment of the packing tray 502. In one embodiment, the packing tray 502 has a base 504 supporting one or more packing containment units 506, the packing containment units containing a magnetic read/write head, a micro-actuator, or some other component of the hard disk drive. In a further embodiment, these packing containment units are indentations shaped to fit the component being contained. In one embodiment, the corners of the packing tray are chamfered 508. In an alternate embodiment, the corners of the packing tray are squared 510. In one embodiment, an alignment bar 512 acts as a limiter, controlling the interaction between the packing tray and the other trays. In another embodiment, two pinholes 514 control the positioning of the packing tray 502 in relation to other trays.

FIG. 5b illustrates one embodiment of the exchange tray 516. In one embodiment, the exchange tray 516 has a base 518 supporting one or more exchange containment units 520, the exchange containment units 520 matching the packing containment units 506 so as to allow components stored in the packing containment units 506 to be easily transferred from the packing containment units 520 to the exchange containment units 506. In a further embodiment, these exchange containment units 520 are indentations shaped to fit the component being contained. In one embodiment, if the corners of the packing tray are chamfered 508, the corners of the exchange tray are chamfered 522. In an alternate embodiment, if the corners of the packing tray are squared 510, the corners of the exchange tray are squared 524. In one embodiment, an alignment indentation 526 acts as a limiter and is fitted to the limiter 512 of the packing tray 502. In another embodiment, two pinholes 528 allow the exchange tray to be aligned exactly above the packing tray 502.

FIG. 5c illustrates an alternate embodiment of the alignment bar limiter 528. In one embodiment, the alignment bar limiter is attached to either the exchange tray 516 or the packing tray 502, with corresponding indentations in the opposing tray. FIG. 5d illustrates one embodiment of a packing method using the packing trays 502.

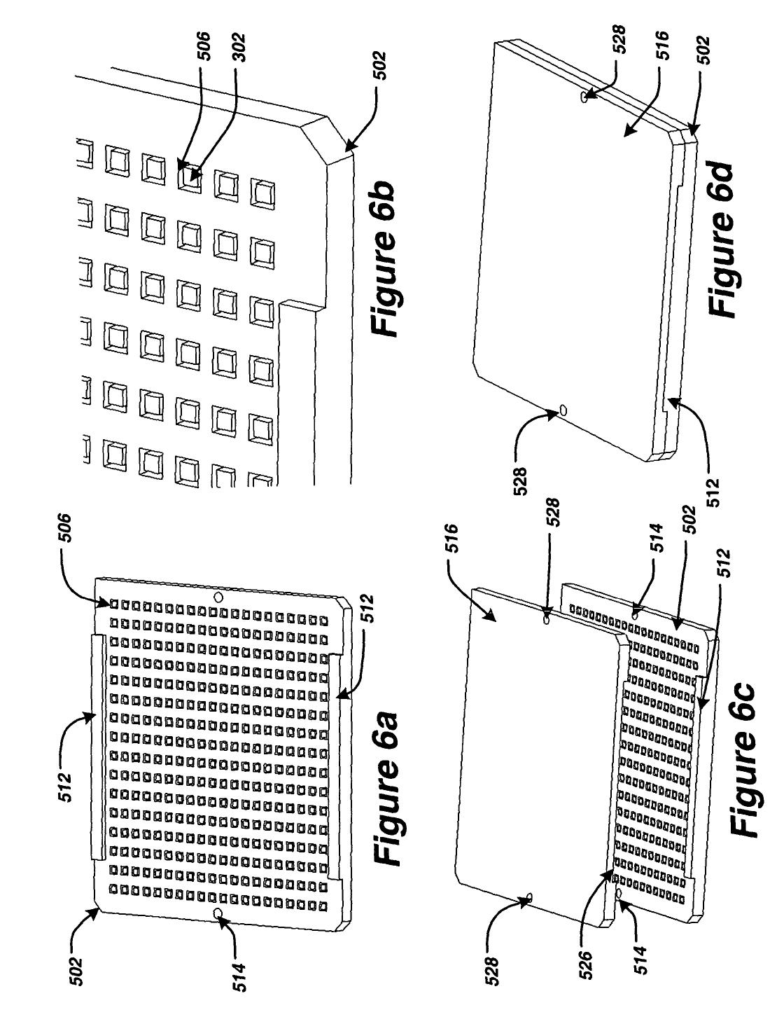

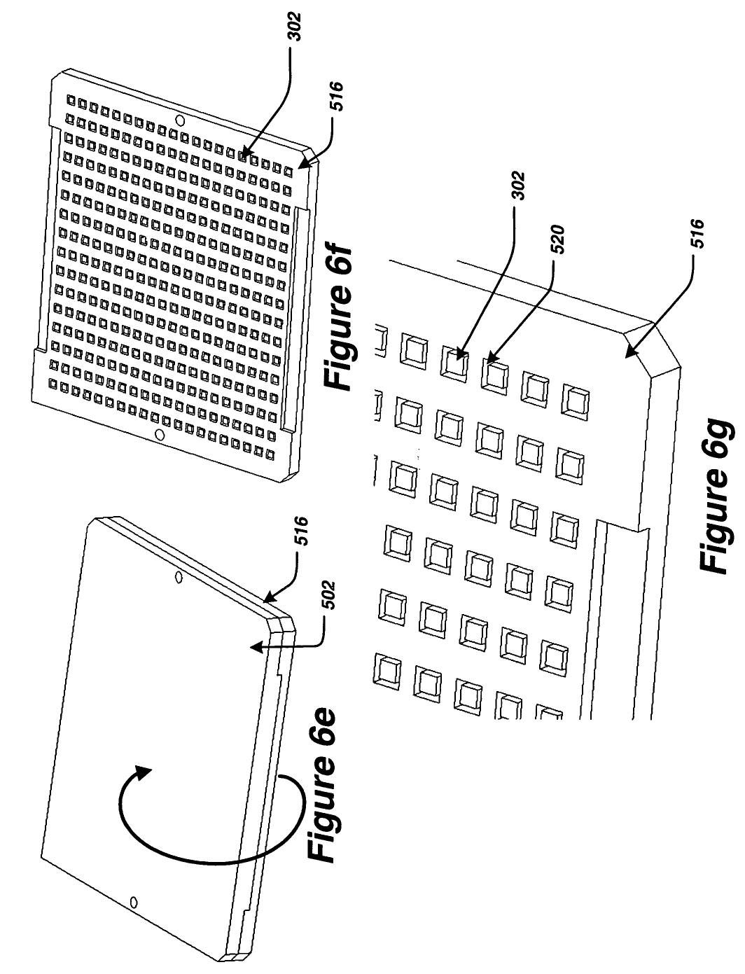

FIGS. 6a-g illustrate one embodiment of the interaction of the exchange tray with the packing tray. FIG. 6a illustrates one embodiment of a packing tray 502 containing multiple magnetic read/write heads 202 or micro-actuators available for inspection on one side. FIG. 6b shows a close-up of this embodiment of the packing tray 502. In one embodiment, each of the magnetic read/write heads 202 or micro-actuators are placed within a packing containment unit 506. In one embodiment of the exchange process, illustrated in FIG. 6c, the exchange tray 516 is inverted and positioned above the packing tray 502. In one embodiment, the exchange tray pinholes 528 are aligned with the packing tray pinholes 514 and the alignment indentation 526 is aligned with the alignment bar 512, causing the packing containment units 506 to be aligned with the exchange containment units 520.

In one embodiment illustrated in FIG. 6d, the exchange tray 516 is placed together with the packing tray 502. In one embodiment illustrated in FIG. 6e, the exchange tray 516 and the packing tray 502 are rotated to position the packing tray 502 on top and the exchange tray 516 on the bottom. Gravity moves each magnetic read/write head 202 or micro-actuator from the packing containment unit 506 to the exchange containment unit 520. In one embodiment shown in FIG. 6f, the packing tray is removed, leaving the exchange tray 516 with the magnetic read/write heads 202 or micro-actuator available for inspection on the opposite side. FIG. 6g shows an enhanced view of the exchange tray 516, in which each magnetic read/write head 202 or micro-actuator is in an exchange containment unit 520.

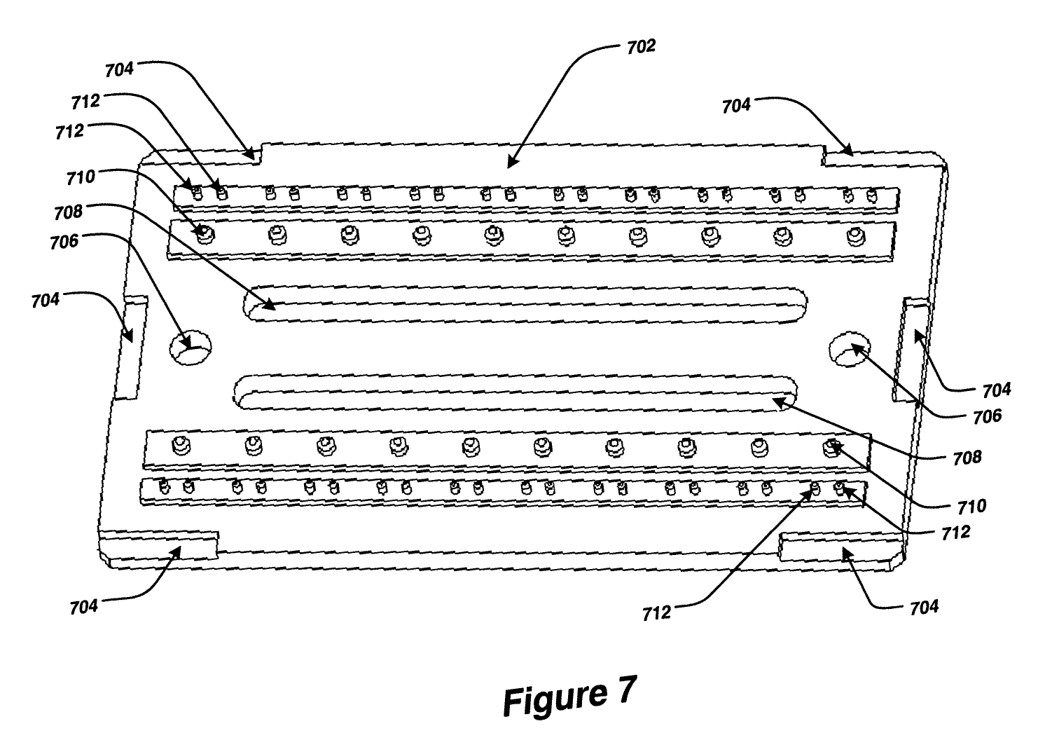

An alternate embodiment of a packing tray, to be used to store a set of head gimbal assemblies 314 or suspensions, is shown in FIG. 7. In one embodiment, the packing tray 702 has a series of packing alignment indentation limiters 704 and a pair of packing alignment pinholes 706. In a further embodiment, the packing tray 702 has a pair of ventilation slots 708 running through the center of the tray 702. In one embodiment, multiple packing sets of pins, each one including a main pin 710 and two secondary pins 712, are attached to the packing tray 702 to hold in place an HGA 314.

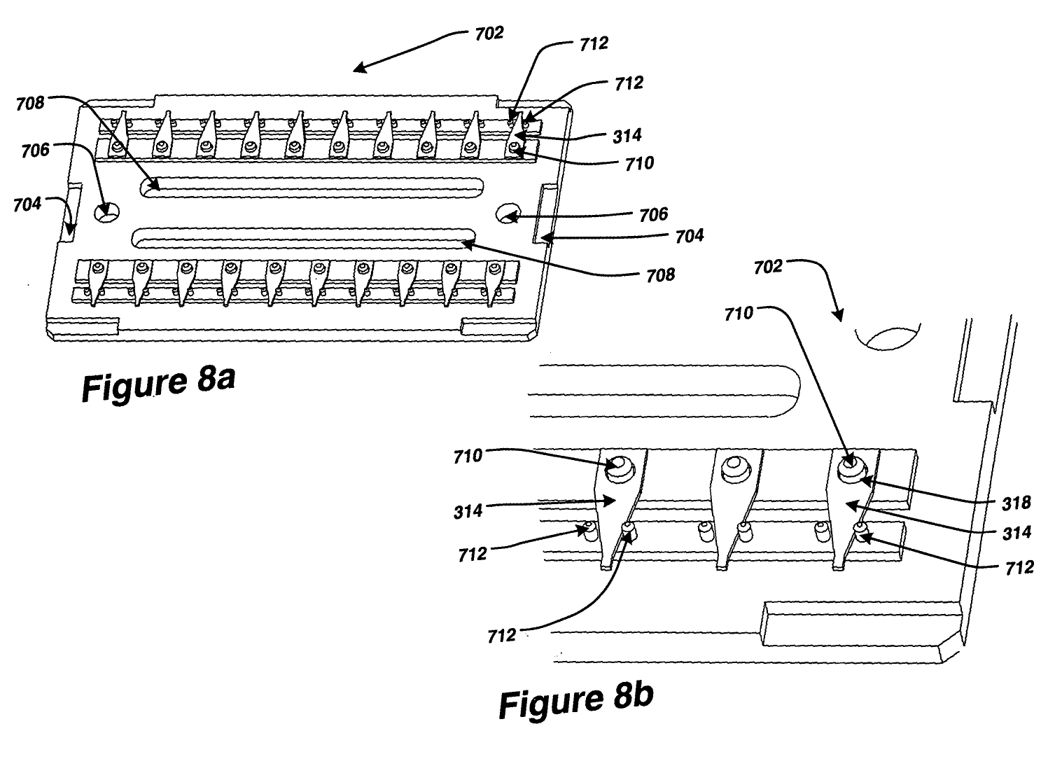

FIG. 8a illustrates the packing tray as used in one embodiment of the current method. FIG. 8b provides an enhanced view of the same embodiment, in which the main pin 710 is inserted into the pivot hole 318 of the HGA 314. In a further embodiment, the secondary pins 712 are used to hold in place the load beam of the HGA 314 or the forward arm of the suspension. The head gimbal assemblies 314 or the head suspensions are then available for visual inspection on this side.

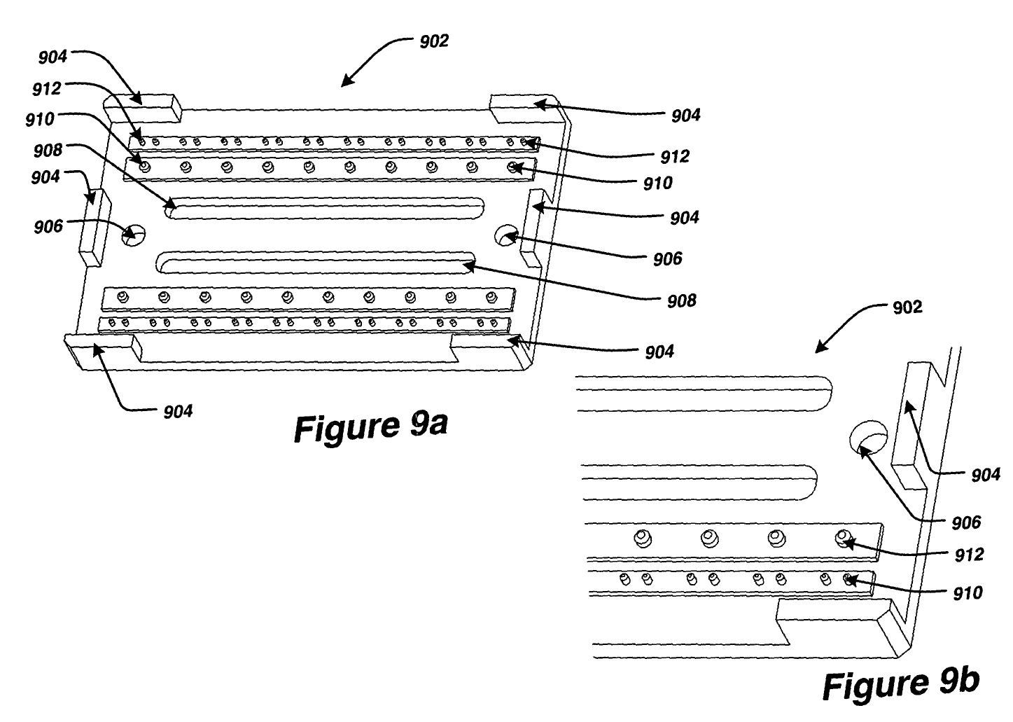

An alternate embodiment of an exchange tray, to be used to exchange a set of head gimbal assemblies 314 or suspensions, is shown in FIG. 9a. In one embodiment, the exchange tray 902 has a series of exchange alignment bar limiters 904 and a pair of exchange alignment pinholes 906. In a further embodiment, the exchange tray 902 has a pair of ventilation slots 908 running through the center of the tray 902. In one embodiment illustrated in the enhanced view of FIG. 9b, multiple exchange sets of pins, including a main pin 910 and two secondary pins 912, are attached to the exchange tray 902 to receive an HGA 314 from the packing tray 702.

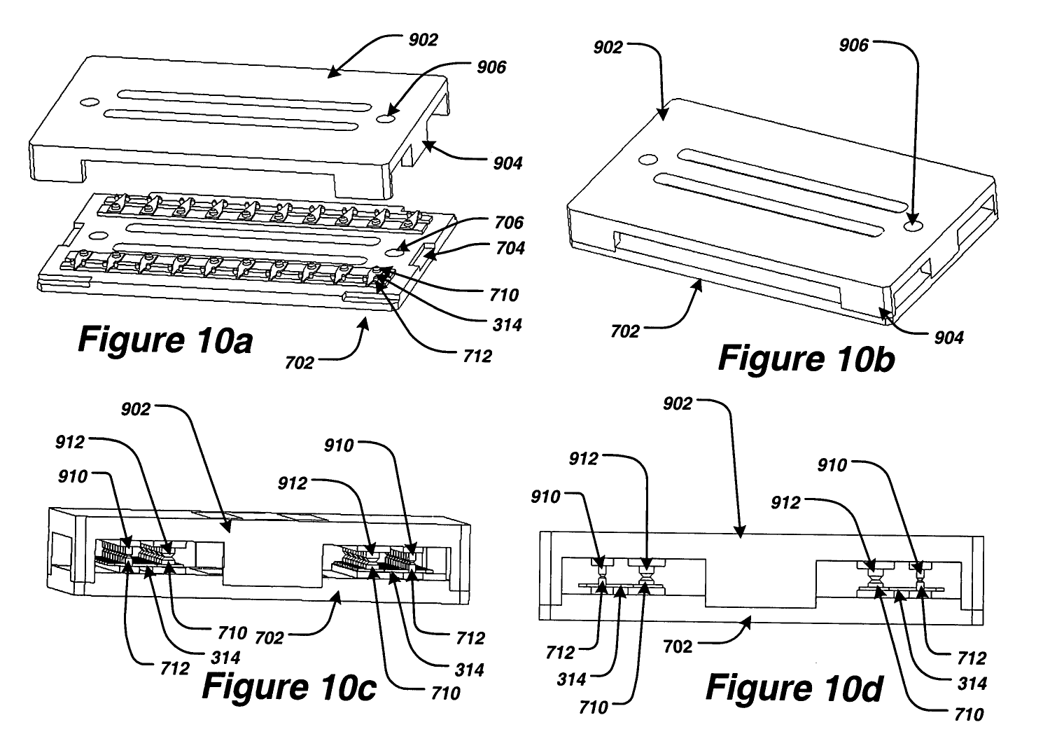

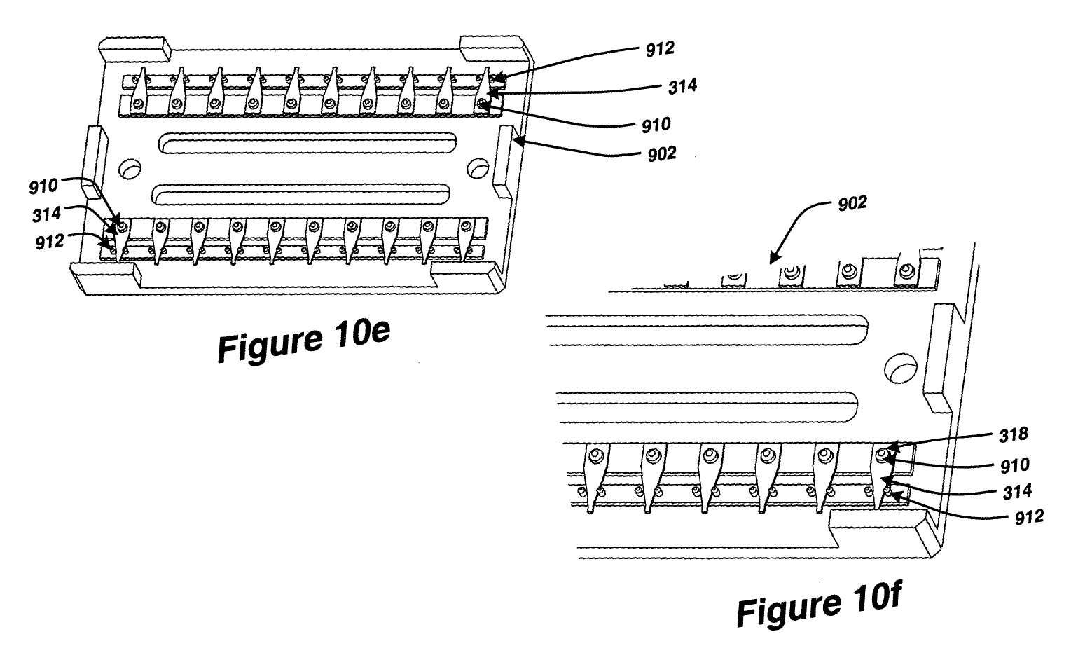

In one embodiment of the next step in the exchange process, as illustrated in the FIG. 10a, the exchange tray 902 is inverted and placed above the packing tray 702. In one embodiment, one or more of the packing sets of pins has an HGA 314 affixed to it, with the pivot hole 318 around the main pin 910 and the arm of the HGA between the two secondary pins 912. In one embodiment, the exchange alignment bar limitations 904 are aligned above the corresponding packing alignment indentation limitations 704 and the exchange alignment pinholes 906 are aligned above the packing alignment pinholes 706, causing the exchange set of pins to be positioned above the packing set of pins. As shown in FIG. 10b, the exchange tray 902 is pressed to the packing tray 702, with the exchange alignment bars 904 inserted into the packing alignment indentations 704. In one embodiment, the two trays are joined together by inserting a pin through an exchange pinhole 906 and a packing pinhole 706. As shown in the perspective view of FIG. 10c and the side view of FIG. 10d, the head gimbal assemblies all are placed so that the main pins 710 of the packing tray 712 are in the pivot holes 318 of the head gimbal assemblies, and the arms of the head gimbal assemblies 314 are between the secondary pins 712.

In one embodiment of the process, the two trays are then rotated so that the exchange tray 902 is on bottom and the packing tray 702 is on top, using gravity to shift the head gimbal assemblies 314 or the head suspensions from the packing tray to the exchange tray. As illustrated in FIG. 10e, the packing tray 702 is removed so that the opposite sides of the head gimbal assemblies 314 or the head suspensions are available in the exchange tray 902 for visual inspection. As shown in the enhanced the view of FIG. 10f, the head gimbal assemblies or the head suspensions now rest in the exchange tray 902, with the pivot holes 318 around the main pins 910 and the arm of the head gimbal assemblies positioned between the secondary pins 912.

Although several embodiments are specifically illustrated and described herein, it will be appreciated that modifications and variations of the present invention are covered by the above teachings and within the purview of the appended claims without departing from the spirit and intended scope of the invention.

1. An exchange tray comprising:
an exchange containment unit matching a packing containment unit of a packing tray to receive a component of a hard disk drive; and
an exchange base to support the exchange containment unit.

2. The exchange tray of claim 1, wherein the exchange tray is able to contain a plurality of components.

3. The exchange tray of claim 1, wherein the exchange containment unit is an indentation shaped to hold the component.

4. The exchange tray of claim 1, wherein the exchange containment unit is a set of pins to hold the component.

5. The exchange tray of claim 1, further comprising a limiter attached to the exchange base to match a limiter of the packing tray.

6. The exchange tray of claim 1, wherein the component is a magnetic read/write head.

7. The exchange tray of claim 1, wherein the component is a micro-actuator.

8. The exchange tray of claim 1, wherein the component is a head gimbal assembly.

9. The exchange tray of claim 1, wherein the component is a head suspension

10. The exchange tray of claim 1, further comprising at least one pin hole in the exchange base matching at least one pin hole in the packing tray.

11. The exchange tray of claim 1, wherein the component is moved from the packing tray to the exchange tray by positioning the exchange tray above and in contact with the packing tray and rotating the packing tray and the exchange tray together.

12. A system, comprising:
a packing tray with a packing containment unit to hold a component of a hard disk drive; and
an exchange tray with an exchange containment unit matching the packing containment unit to receive the component.

13. The system of claim 12, wherein the exchange tray and the packing tray are able to contain an equal plurality of components.

14. The system of claim 12, wherein the exchange containment unit is an indentation shaped to hold the component.

15. The system of claim 12, wherein the exchange containment unit is a set of pins to hold the component.

16. The system of claim 12, further comprising a limiter attached to the exchange base to match a limiter of the packing tray.

17. The system of claim 12, wherein the component is a magnetic read/write head.

18. The system of claim 12, wherein the component is a micro-actuator.

19. The system of claim 12, wherein the component is a head gimbal assembly.

20. The system of claim 12, wherein the component is a head suspension.

21. The system of claim 12, further comprising at least one pin hole in the exchange base matching at least one pin hole in the packing tray.

22. The system of claim 12, wherein the component is moved from the packing tray to the exchange tray by positioning the exchange tray above and in contact with the packing tray and rotating the packing tray and the exchange tray together.

23. A method, comprising:
placing a component of a hard disk drive in a packing containment unit of a packing tray;
positioning an exchange tray with an exchange containment unit matching the packing containment unit above and in contact with the packing tray; and
rotating the packing tray and the exchange tray together to move the component from the packing tray to the exchange tray.

24. The method of claim 23, further comprising:
holding a plurality of components in the packing tray simultaneously; and
transferring the plurality of components to the exchange tray simultaneously.

25. The method of claim 23, wherein the exchange containment unit is an indentation shaped to hold the component.

26. The method of claim 23, wherein the exchange containment unit is a set of prongs to hold the component.

27. The method of claim 23, wherein a limiter attached to the exchange base matches a limiter of the packing tray.

28. The method of claim 23, wherein the component is a magnetic read/write head.

29. The method of claim 23, wherein the component is a micro-actuator.

30. The method of claim 23, wherein the component is a head gimbal assembly.

31. The method of claim 23, wherein the component is a head suspension.

32. The method of claim 23, further comprising securing at least one pin hole in the exchange base to at least one pin hole in the packing tray.
